(19) United States
(12) Patent Application Publication
(10) Pub. No.: US 2014/0078067 A1
(43) Pub. Date: Mar. 20, 2014

(54) MEDICAL IMAGE DISPLAY AND DATA TRANSFER

(71) Applicant: Andrew David Stonefield, Wauwatosa, WI (US)

(72) Inventor: Andrew David Stonefield, Wauwatosa, WI (US)

(73) Assignee: GENERAL ELECTRIC COMPANY, Schenectady, NY (US)

(21) Appl. No.: 13/616,560

(22) Filed: Sep. 14, 2012

(51) Int. Cl. G06F 3/041

(52) U.S. Cl. 345/173

(57) ABSTRACT

An apparatus for displaying medical images and directing the transfer of data representative of the displayed image is disclosed. A touch screen designed to display the medical image also displays functional buttons which, when activated, direct the transfer of the image data to various destinations. Each such functional button becomes associated with text and/or an icon identifying a given destination when it is programmed to direct data to that destination.

### BACKGROUND

Medical images from medical imaging systems such as an ultrasonic system examination of humans are displayed on a display monitor. Medical images are often saved for analysis and/or archive purposes on various types of devices. Additionally, medical images may be printed by a printer for analysis by a physician, for placement in a physical patient file and/or for the patient to retain for their own private records.

### SUMMARY

One embodiment includes an apparatus for transferring medical images using a touch screen device including both a display surface and a processor. The device is designed to display a medical image of a portion of the interior of a human body and displays functional buttons programmable to direct the transfer of data representative of the medical image to various locations. When each button is programmed it becomes associated with text and/or icons visible on the display surface which indicate the locations to which it directs the image data. The touch screen device has a transmission link for the receipt of the data and one or more transmission links for the delivery of the data to the various locations associated with the programmable buttons. The apparatus may also include a data storage device which stores the data representative of the medical image and supplies it upon request from the touch screen device.

Another embodiment includes a method to transfer a medical image using a touch screen device which has functional buttons displayed on its screen and which is designed to display a medical image of a portion of the interior a human body. The functional buttons are programmed to direct the transfer of data representative of the medical image to various locations such that each button becomes associated with text and/or icons which indicate the locations to which it will transfer the image data. Such a medical image is transferred to the touch screen and one of the buttons is activated to transfer data representative of the medical image to a given location.

In another embodiment an apparatus for transferring medical images comprises a touch screen device including a display surface connected to a processor which causes it to display both a medical image of a portion of the interior a human and functional buttons programmable to direct the transfer of data representative of the medical image to various locations. When each button is programmed it becomes associated with text and/or icons which indicate the locations that it is capable of directing the image data. A data storage device stores the data representative of the medical image and supplies it upon request from the processor. The apparatus includes a communications link from a source of the medical image to the touch screen device and includes communications links from the touch screen device to each of the locations.

### BRIEF DESCRIPTION OF THE DRAWINGS

FIG. 1 is a schematic illustration of a touch screen device which transfers image data to image data destinations.

FIG. 2 is a schematic illustration of a programming interface in a first state.

FIG. 3 is a schematic illustration of a programming interface in a second state.

### DETAILED DESCRIPTION

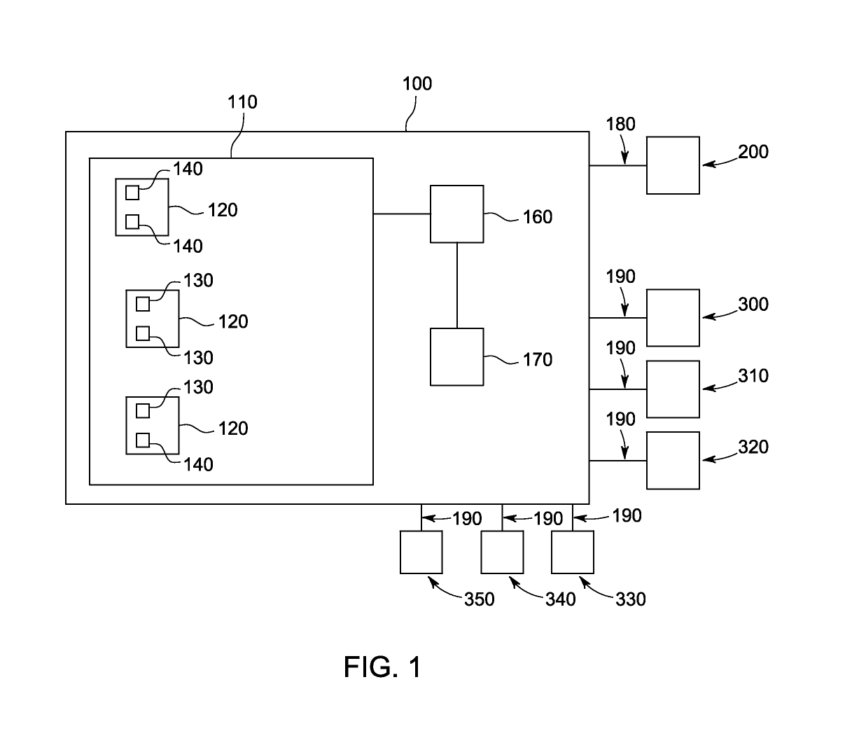

Referring to FIG. 1 one embodiment of the touch screen device 100 is capable of transferring medical image data to various destinations. Touchscreen device 100 includes a display screen that is sensitive to the touch of a finger or stylus and has a display surface 110 which displays at least one functional buttons 120. In one embodiment, display surface 110 may display three functional buttons. Each functional button in turn carries either text 130 or an icon 140 or a combination of both. The text 130 or icon 140 appearing on a given button 120 indicates the destinations to which that button has been programmed to direct image data. Buttons 120 are a graphical user interface that appears on the display screen.

The device 100 also has a processor 160, which controls the receipt and transmission of image data as well as the display on the display screen 110, and a data storage device 170 including memory where image data is held for use in creating a display on the display screen 110 and for transmission in accordance with direction of the functional buttons 120 and a processor 160.

For purposes of this application, the term “processor or processing unit” shall mean a presently developed or future developed processing unit that executes sequences of instructions contained in a memory. In one example the term “memory” as used herein comprises a non-transient computer-readable medium containing computer code for the direction of controller. Execution of the sequences of instructions causes the processing unit comprising controller to perform steps such as directing the generation of an ultrasound signal and processing and storing the signals received from the ultrasound detector, directing the transfer of data representative of the medical image to a particular location. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described.

Medical image data is provided to the touch screen device 100 by an incoming communication link 180 from an ultrasonic probe 200. The communication link 180 may include a wire or cable or it may be a wireless connection. Probe 200 may be any device capable of providing medical image data from an interior portion of a human body. The medical image data is directed by the processor 160 to the display surface 110, the data storage device 170 or one of the outbound communications links 190.

Communication links 190 may include a wire, cable or wireless connection. These outbound communications links 190 each lead to one of six different destinations 300, 310, 320, 330, 340 and 350, which are a memory stick (flash drive), a printer, a cloud site on the internet, a folder on a local area net work, a write capable DVD drive and a computer hard drive, respectively. Though six destinations are identified in one embodiment, other embodiments may include less than or more than six destinations.

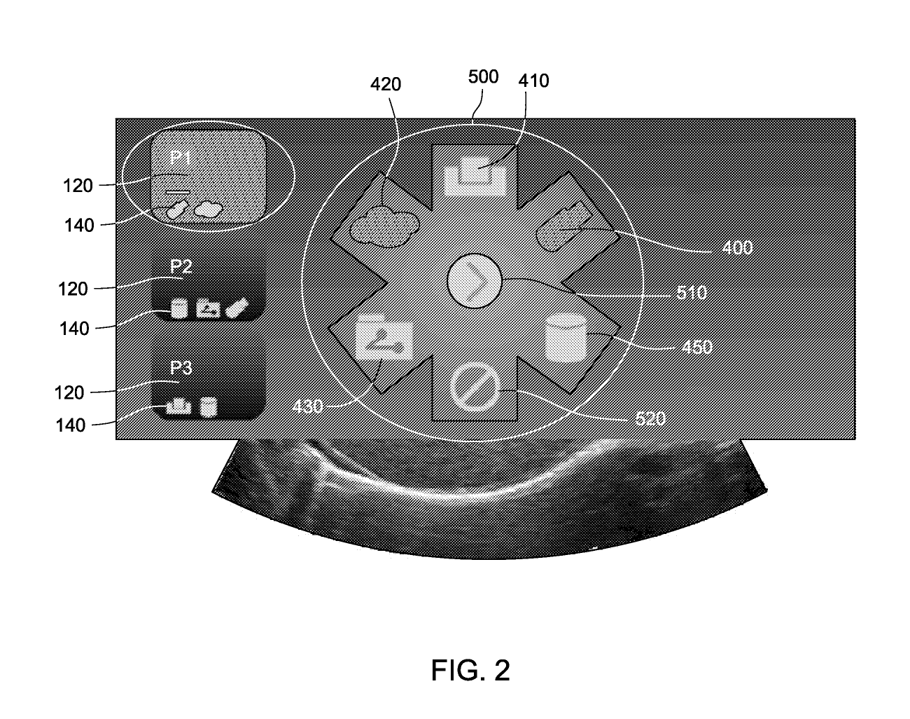

Referring to FIG. 2 programming interface 500 is used to assign destinations 300-350 to functional buttons 120. In this illustration destination 340 is not displayed. However, it is possible to display destination 340 or additional destinations by modifying interface 500 by providing additional arms to for example. Other interface concepts are also contemplated such as a wheel, list of files, or other display geometry in which various destinations are displayed and may be selected. For each image data destination 300, 310, 320, 330 and 350 the interface 500 displays a path 400, 410, 420, 430 and 450, respectively. A given button 120 is programmed using the selector 510 to associate it with particular destinations. As illustrated, the first of the programmable functional buttons 120 also identified as P1 has been associated with the path 400 to destination 300, a memory stick, and with the path 420 to destination 320, a cloud site on the internet. These two paths 400 and 420 give a color indication, illustrated by appropriate shading, that the association has been successful. This programming automatically causes appropriate icons 140 to appear within the display of the functional button 120 on the display surface 110. The association of a functional button 120 with any given destination path can be ended by the use of the deletion key 520.

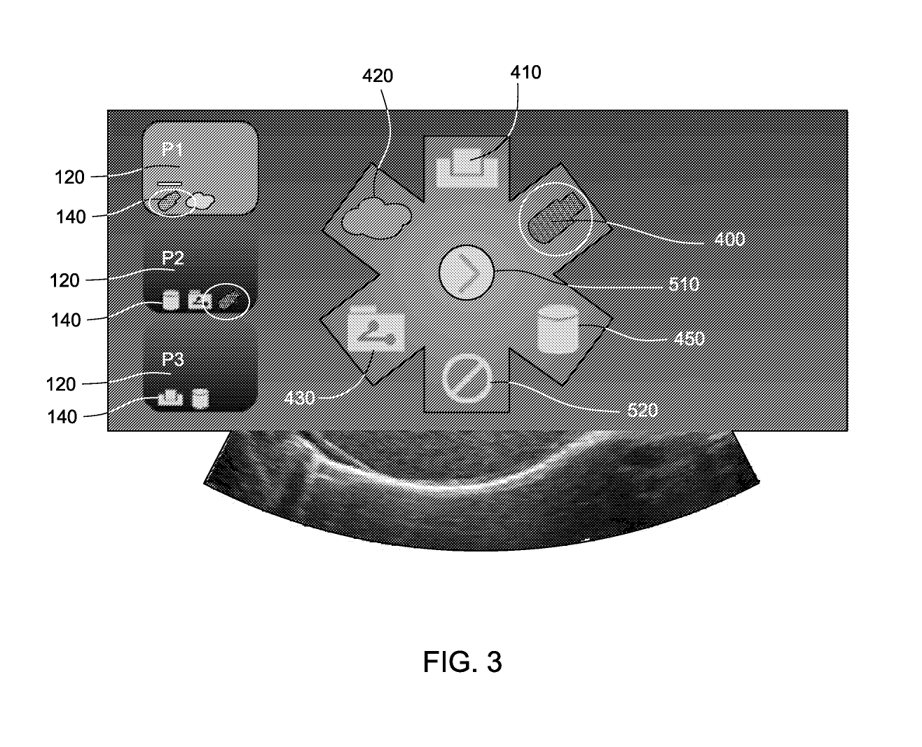

Referring to FIG. 3 the same programming interface 500 is shown, but in this case with a display that one of the destination paths, 400 leading to the memory stick 300, is not available via a color indication different from that used to show a successful association between a functional button 120 and one or more paths (illustrated with appropriate shading).

One implementation meaningfully facilitates the transfer of data representative of a medical image. It allows the user to examine the medical image on a display and then to readily direct the transfer of data representative of that image to one of a number of possible locations from the same the same display without having to remember or to consult a log to know the destinations to which a given functional button will direct image data. In one embodiment the display of the functional button includes such destination information in the form of text or an icon or both. In another embodiment the text or icon may be associated with a given button without appearing within the display of that button. In one embodiment the text or icon gives an indication when its associated destination is unavailable. For instance, the icon associated with a memory stick may display a different color or have a different light intensity when the memory stick has been removed. In one embodiment the text or icon associated with a given destination on a given button or the button itself may give an indication when there has been a successful data transfer.

A given button may be programmed to operate by simply being activated by pressure or by merely positioning a person's finger proximate the relevant graphical user interface on the touch screen while its each of its associated destinations is indicated for a brief time and a given destination is selected by releasing the pressure and or positioning one's finger proximate the button. Alternatively, a given button may be programmed to be toggled between its associated destinations by repeatedly pressing the button or repeatedly approaching and removing a user's finger from the relevant interface and/or button.

The graphical programming interface and the automatic association of a given functional button with an indicator of a data destination when it is programmed to that destination meaningfully facilitates adjustments to the data transfer capabilities of a touch screen device for the display of medical images. Thus a routine user of this device, such as a physician or a medical technologist, may make appropriate adjustments without the intervention of an information technology (IT) professional.

The input to the touch screen device may come from any source capable of generating a medical image. In one embodiment this source is an instrument which generates an image of the interior of a portion of the human body such as an x-ray, MRI or ultrasonic (US) instrument. In one embodiment the input is from an ultrasonic probe and the touch screen device includes a processor which can use the signals from the probe to create an image on its display screen.

The destinations of the image data may be any device capable of receiving such data. This includes a memory stick or flash drive, a printer, a server maintaining an internet cloud site, a server which is part of a local area network (LAN), a DVD drive capable or writing to a DVD or the hard drive of a computer. In one embodiment a destination is a picture archiving and communications system (PACS) and the image data is converted to the digital imaging and communications for medicine (DICOM) format. The conversion to the DICOM format may be done by the touch screen device processor or by a processor associated with the PACS destination.

In one embodiment a user continuously touches or presses the functional button 120 denominated P1 with a stylus or his finger until the programming interface appears on the screen. He then touches or presses the programming selector 510 is to cause it rotate clockwise with each touch or press causing it to increment until its arrow points to the memory stick path indicator 400. He then continuously touches or presses the programming selector 510 until both the memory stick path indicator 400 and the functional button 120 denominated P1 turn green indicating that the P1 button has been programmed to direct image data to the memory stick 300. At this point an icon 140 representing the memory stick 300 appears within the display of the button P1. This user once again touches or presses the programming selector 510 to cause it rotate clockwise until its arrow points to the internet cloud site path indicator 420. He once again continuously touches or presses programming selector 510 until both internet cloud site path indicator 420 and the functional button 120 denominated P1 turn green indicating that the P1 button has been programmed to direct image data to the cloud site on the internet. At this point an icon 140 representing the internet cloud site 320 appears within the display of the button P1. He then exits the programming interface by a quick touch or press of functional button P1.

This user uses the same procedure to program functional buttons P2 and P3. In other words, he touches or presses functional button P2 or P3 continuously with a stylus or his finger until the programming interface appears on the screen. He then touches or presses the programming selector 510 to cause it rotate clockwise with each touch or press causing it to increment until its arrow points to the desired path indicator. In the case of P2 this is first the computer hard drive path indicator 450, then the path indicator for the local area network folder 430 and finally memory stick path indicator 400. For each desired path indicator, he continuously touches or presses programming selector 510 until there is an indication that that path has been successfully programmed to functional button P2. As each of these three paths are programmed to functional button P2, an icon representative of the destination to which that path leads appears within the display of functional button P2. In the case of P3 this is first the printer path indicator 410 and then the computer hard drive path indicator 450. The operation of the programming selector 510, the indication of successful programming and the appearance of icons 140 within the display of the functional button P3 are essentially the same as for the programming of functional buttons P1 and P2, except that functional button P3 contains icons 140 for the printer 310 and the computer hard drive 350. He then exits the programming interface by a quick touch or press of functional button P2 or P3, as appropriate.

The programming of each of the functional buttons P1 through P3 is readily apparent from the icons 140 contained within the display of each of them. Also readily apparent from the order of the icons 140 within the display of each functional button 120 is the number times that a given functional button 120 needs to be touched or pressed to direct image data to be directed to a destination represented by a given icon. In one implementation, a single touchy or push of functional button 120 results in the data being directed to the destination associated with each icon shown in that functional button 120. In another implementation a single touch or press is required to direct image data to the destination represented by the first or leftward most icon, while directing image data to the destination associated with the icon in the next position requires two touches or presses and so on.

The programming interface 500 is provided with a deletion key 520 so that the association of a functional button 120 with a given destination can be readily reversed. A user continuously touches or presses a functional button 120 until the programming interface 500 is displayed. He then touches or presses the programming selector 510 to rotate it incrementally clockwise until its arrow points to the deletion key 520. This user now continuously touches or presses the programming selector 510 until the most leftward icon 140 facing the button ceases to display within this functional button 120. This indicates that this functional button 120 is no longer associated with the data destination represented by the deleted icon. He can repeat the operation of the programming selector 510 until all the icons 140 associated with this functional button have been removed from its display.

The deletion key 520 can be used in the same manner with any of the other functional buttons 120. The functional button to be modified is used to bring up the programming interface 500 and the programming selector 510 is appropriately rotated and held to cause the desired deletions.

A user uses the operation of the deletion key 520 to edit or update the destinations to which a given functional button 120 will direct the transfer of medical image data. For instance, if this user wants the destination associated with a single touch or press of the functional button P1 to be an internet cloud site 320 but the most leftward icon now displayed represents the memory stick destination, he uses the above described operation of the deletion key 520 to remove the icon 140 representing the memory stick 300. He then rotates the programming selector 510 until its arrow points to the memory stick path indicator and then continuously touches or presses the programming selector 510 until he notes the color indication and the appearance of the icon 140 representing the memory stick destination in the display of this button. This user has now edited the programming of the functional button P1 to change the order in which it directs the transfer of medical image data so that a single touch or push will direct this data to the internet cloud site 320 first and then to the memory stick destination 300.

A user of the touch screen device now directs data representative of the medical image appearing on the display surface 120 to the memory stick 300 and to the internet cloud site 420 by touching or pressing the functional button P1 once.

In one embodiment when destination 300, a memory stick, becomes temporarily unavailable, its path indicator 400 in the programming interface 500 and its icon 140 in each of the functional buttons 140 in which it is displayed turn a color such as orange, red or yellow that represents to the user that the destination is not available.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus for transferring medical images comprising:
a touch screen device including both a display surface and a processor, the device designed to display a medical image of a portion of the interior of a human body and displays functional buttons programmable to direct the transfer of data representative of the medical image to various locations; wherein upon being programmed each button becomes associated with text and/or icons visible on the display surface which indicate the locations to which it directs the image data; the touch screen device having a transmission link for the receipt of the data; and one or more transmission links for the delivery of the data to the various locations associated with the programmable buttons.

2. The apparatus of claim 1 wherein the text or the icons appear within the image of the functional buttons.

3. The apparatus of claim 1 wherein the image is obtained from x-ray, MRI or ultrasonic examination of a portion of a human body.

4. The apparatus of claim 3 wherein the image is obtained from ultrasonic examination of a portion of a human body.

5. The apparatus of claim 1 wherein at least one of the transmission links is wireless.

6. The apparatus of claim 1 wherein the text or icon associated with a given data indicates when that location is not available.

7. The apparatus of claim 6 wherein the indication is a change in color.

8. The apparatus of claim 1 wherein the text or icon associated with a given data location indicates when a transfer of data to that location has been successful.

9. The apparatus of claim 1 wherein the interface for programming the functional buttons has at least one graphical indicator illustrative of a given data location.

10. The apparatus of claim 1 wherein the interface for programming the functional buttons allows programming more than one location to each button.

11. A process for the transfer a medical image comprising:
programming functional buttons on a touch screen, which screen is adapted to display a medical image of a portion of the interior a human body, to direct the transfer of data representative of the medical image to various locations such that each button becomes associated with text and/or icons which indicate the locations to which it will transfer the image data; transferring a medical image of a portion of the interior a human body to the touch screen; and activating one of the buttons to transfer data representative of the medical image to a given location.

12. The process of claim 11 wherein the text and/or icon associated with a given location indicates when that location is unavailable for the receipt of the medical image data.

13. The process of claim 12 wherein the indication is a change in color.

14. The process of claim 11 wherein at least one of the functional buttons has been programmed to direct the transfer of data to more than one location.

15. The process of claim 11 wherein the interface for programming the functional buttons has at least one graphical indicator illustrative of a given data location.

16. An apparatus for transferring medical images comprising:
a touch screen device comprising a display surface connected to a processor which causes it to display both a medical image of a portion of the interior a human and functional buttons programmable to direct the transfer of data representative of the medical image to various locations, wherein upon being programmed each button becomes associated with text and/or icons which indicate the locations to which it is capable of directing the image data; a data storage device that stores the data representative of the medical image and supplies it upon request from the processor; a communications link from a source of the medical image to the touch screen device; and communications links from the touch screen device to each of the locations.

17. The apparatus of claim 16 wherein the interface for programming the functional buttons gives an indication when a given button has been programmed in accordance with input to the interface.

18. The apparatus of claim 18 wherein the indication involves a change in color.

19. The apparatus of claim 16 wherein one of the locations includes a processor to convert the data to the DICOM format.

20. The apparatus of claim 19 wherein one of the data locations is a PACS.
